(19) United States
(12) Patent Application Publication
(10) Pub. No.: US 2018/0314361 A1
(43) Pub. Date: Nov. 1, 2018

(54) TOUCH DISPLAY DEVICE

(71) Applicant: InnoLux Corporation, Jhu-Nan (TW)

(72) Inventors: Huei-Ying CHEN, Jhu-Nan (TW); Kuo-Shun TSAI, Jhu-Nan (TW); Hao-Yu LIOU, Jhu-Nan (TW); Yu-Sheng CHEN, Jhu-Nan (TW); Hong-Sheng HSIEH, Jhu-Nan (TW); Jian-Cheng CHEN, Jhu-Nan (TW); Wen-Ping YANG, Jhu-Nan (TW); Cheng-Hsia KUO, Jhu-Nan (TW)

(21) Appl. No.: 15/954,323

(22) Filed: Apr. 16, 2018

(30) Foreign Application Priority Data
Apr. 26, 2017 (CN) 201710281283.5

(51) Int. Cl. G06F 3/044

(52) U.S. Cl. CPC G06F 3/044; G06F 2203/04107; G06F 2203/04111

(57) ABSTRACT

A touch display device includes a first substrate, a first touch pattern and an insulation layer. The first touch pattern is disposed on the first substrate, and the insulation layer is disposed on the first substrate. The insulation layer and the first touch pattern are overlapped. The insulation layer includes a protection layer and a dielectric layer, and the dielectric layer is disposed between the protection layer and the first substrate. A material of the protection layer includes an oxide, and a material of the dielectric layer comprises silicon nitride or silicon oxynitride.

### CROSS REFERENCE TO RELATED APPLICATIONS

This Non-provisional application claims priority under 35 U.S.C. § 119(a) on Patent Application No(s). 201710281283.5 filed in People's Republic of China on Apr. 26, 2017, the entire contents of which are hereby incorporated by reference.

### BACKGROUND

### Technical Field

This disclosure relates to a touch display device.

### Related Art

With the progress of technologies, various information devices, such as mobile phones, tablet computers, ultra-mobile PC (UMPC), and global positioning system (GPS), have been invented and introduced into our lives. Except the conventional input tools such as keyboards or mice, the intuitional touch input technology has been developed and becomes a popular operation method. Since the touch display device has a humanized and intuitional input operation interface, the users of any ages can simply and directly use the finger or stylus to click or control the information device.

The capacitance touch display device usually senses the touch event by the touch sensing circuit. In general, the touch sensing circuit is usually made of a transparent conductive layer, and can serve as a driving electrode (Tx) or a sensing electrode (Rx) according to the function of the touch sensing circuit. The driving electrode intersects with the sensing electrode and is electrically isolated with the sensing electrode. In order to intersect and isolate the driving electrode and the sensing electrode, a dielectric layer can be provided to separate and electrically isolate the driving electrode and the sensing electrode. The insulation material of the dielectric layer usually includes an organic photoresist, an inorganic material, or an organic photoresist doped with inorganic material.

However, after the touch display device is operated for a certain time, the insulation property of the dielectric layer may be weakened due to the environment factors, such as light, water, or dusts. This weakened insulation property may cause the misoperation of the user, and further lead to the damage of the touch display device.

### SUMMARY

The disclosure provides a touch display device including a first substrate, a first touch pattern and an insulation layer. The first touch pattern is disposed on the first substrate, and the insulation layer is disposed on the first substrate. The insulation layer and the first touch pattern are overlapped. The insulation layer includes a protection layer and a dielectric layer, and the dielectric layer is disposed between the protection layer and the first substrate. A material of the protection layer includes an oxide, and a material of the dielectric layer comprises silicon nitride or silicon oxynitride.

In the touch display device of this disclosure, the protection layer is made of an oxide material and is disposed on the dielectric layer for protection the dielectric layer, which is made of silicon nitride or silicon oxynitride. This configuration can maintain the insulation property of the dielectric layer. Based on the structural design of this disclosure, the insulation property of the dielectric layer of the touch pattern can be remained stable, thereby improving the insulation protection ability and product reliability of the touch display device. According to some embodiments, the dielectric layer can also be used as an index matching film (IMF) cooperated with the transparent conductive layer (touch pattern) for improving the color cast of the dark frame of the touch display device and keeping the high transmittance and good visibility.

### BRIEF DESCRIPTION OF THE DRAWINGS

The embodiments will become more fully understood from the detailed description and accompanying drawings, which are given for illustration only, and thus are not limitative of the present disclosure, and wherein:

FIG. 1A is a schematic diagram showing a touch display device according to an embodiment of the disclosure;

FIG. 1B is a side view of the touch display device according to the embodiment of the disclosure;

FIG. 2A is a top view of a touch substrate of the touch display device of FIG. 1B;

FIG. 2B is a cross-sectional view of the touch substrate of FIG. 2A along the line A-A;

FIG. 2C is a cross-sectional view of a touch substrate of another aspect of the disclosure;

FIG. 3 is a schematic graph showing the atom percentage of the X-ray photoelectron spectrum (XPS) according to an embodiment;

FIG. 4A is a top view of a touch substrate of a touch display device of another aspect of the disclosure;

FIG. 4B is a cross-sectional view of the touch substrate of FIG. 4A along the line B-B;

FIG. 5 is a side view of a touch display device according to another embodiment of the disclosure; and

FIG. 6 is a CIE 1976 chromaticity diagram of an embodiment of the disclosure.

### DETAILED DESCRIPTION OF THE INVENTION

The embodiments of the disclosure will be apparent from the following detailed description, which proceeds with reference to the accompanying drawings, wherein the same references relate to the same elements.

In the specification, descriptions about forming another structure above a structure or on a structure may include an embodiment, in which the structure and the another structure directly contact each other, or an embodiment, in which an extra structure is formed between the structure and the another structure and hence the structure and the another structure do not directly contact each other.

The figures of this disclosure show a first direction D1, a second direction D2 and a third direction D3, which are substantially perpendicular to one another, but this disclosure is not limited thereto. The included angles between the first direction D1, the second direction D2 and the third direction D3 may be a sharp angle or an obtuse angle. For example, when the touch display device 1 is a curved touch display device, the included angle between the first direction D1 and the third direction D3 may be a sharp angle or an obtuse angle, and the included angle between the second direction D2 and the third direction D3 may be a sharp angle or an obtuse angle

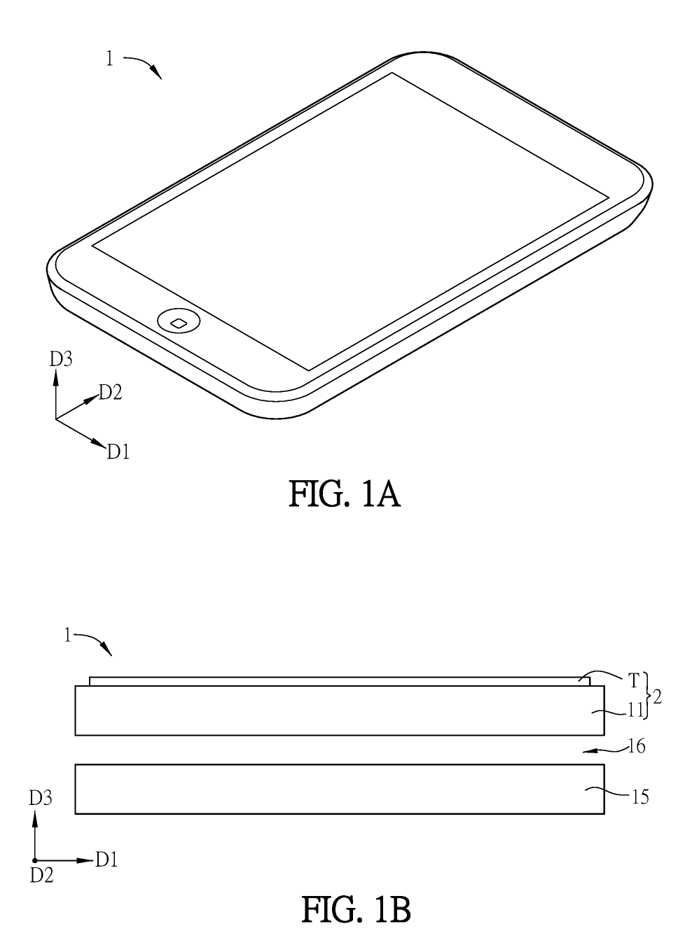

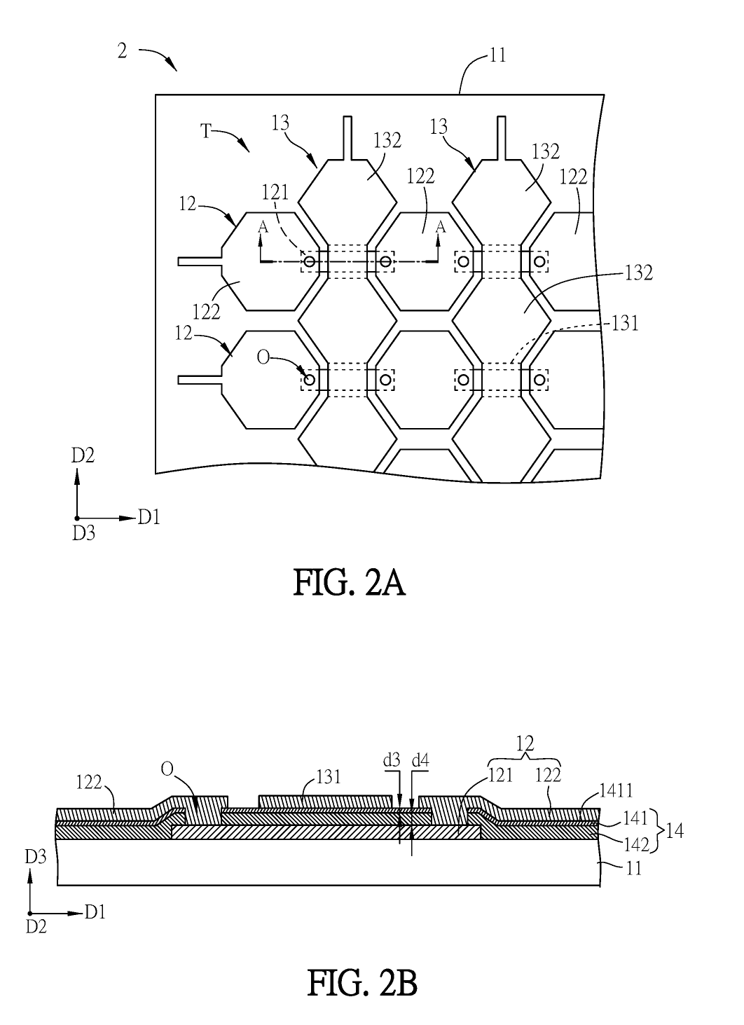

FIG. 1A is a schematic diagram showing a touch display device 1 according to an embodiment of the disclosure, FIG. 1B is a side view of the touch display device 1, FIG. 2A is a top view of a touch substrate 2 of the touch display device 1 of FIG. 1B, and FIG. 2B is a cross-sectional view of the touch substrate 2 of FIG. 2A along the line A-A. The touch display device 1 of this embodiment is, for example but not limited to, a mobile phone. In other embodiments, the touch display device 1 may be a tablet computer, UMPC, large-size display, TV, GPS, or other touch electronic device. In addition, the touch display device 1 can be an out-cell touch display device or an embedded type touch display device. The embedded type touch display device includes the on-cell embedded type touch display device and an in-cell embedded type touch display device. In this embodiment, the touch display device is an on-cell embedded type touch display device.

Referring to FIGS. 1A to 2B, the touch display device 1 includes a first substrate 11, a first touch pattern 12 and an insulation layer 14. In addition, the touch display device 1 further includes a second touch pattern 13, a second substrate 15 and a display medium 16.

The first substrate 11 may be disposed opposite to the second substrate 15, and the display medium 16 (e.g., a liquid crystal layer) may be disposed between the first substrate 11 and the second substrate 15. The material of the first substrate 11 and the second substrate 15 may comprise transparent material such as glass, quartz, or plastics. In addition, the touch display device 1 may further include a TFT (thin-film-transistor) array and a color filter array (not shown). The TFT array may be disposed on the second substrate 15, and the color filter array may be disposed on the first substrate 11 or the second substrate 15. In this embodiment, the TFT array is disposed at one side of the second substrate 15 facing the first substrate 11, and the color filter array is disposed at one side of the first substrate 11 facing the second substrate 15. In other embodiments, the black matrix (BM) layer of the color filter array may be disposed on the second substrate 15 to form a BOA (BM on array) substrate, or the filter layer of the color filter array can be disposed on the second substrate 15 to form a COA (color filter on array) substrate. This disclosure is not limited thereto.

In addition, the touch display device 1 of this embodiment further includes a backlight module (not shown), which is disposed at one side of the second substrate 15 away from the first substrate 11. The light emitted from the backlight module can pass through the pixels formed by the second substrate 15, the TFT array, the display medium 16, the color filter array, and the first substrate 11 so as to display the image.

In some embodiments, the display medium 16 is liquid crystals, so that the first substrate 11, the second substrate 15, the display medium 16, the TFT array, and the color filter array can form a liquid crystal display panel. In other embodiments, the display medium 16 may be a layer including an organic light-emitting diode (OLED), a quantum dot (QD), a fluorescence, a phosphor, a light-emitting diode (LED), a mini light-emitting diode (mini LED), or a micro light-emitting diode (micro LED), but the disclosure is not limited thereto. In some examples, the chip size of the light-emitting diode may be in a range from about 300 μm to about 10 mm. The chip size of the mini light-emitting diode may be in a range from about 100 μm to about 300 μm. The chip size of the micro light-emitting diode may be in a range from about 1 μm to about 100 μm, but the disclosure is not limited thereto.

In this embodiment, for example, the touch display device 1 includes a plurality of first touch patterns 12 and a plurality of second touch patterns 13. Each of the first touch patterns 12 and the second touch patterns 13 may respectively be a transparent conductive layer, such as a transparent conductive oxide (TCO) layer. In specific, the material of the transparent conductive oxide layer may include indium tin oxide (ITO) or indium zinc oxide (IZO). The first touch patterns 12, the second touch patterns 13 and the insulation layer 14 are disposed on the first substrate. The first touch patterns 12, the second touch patterns 13 and the insulation layer 14 can form a touch pattern layer T, and the touch pattern layer T and the first substrate 11 form a touch substrate 2.

In the touch substrate 2, the touch pattern layer T is disposed on one side of the first substrate 11 away from the second substrate 15 (the upper surface of the first substrate 11). The first touch patterns 12 and the second touch patterns 13 can form a touch sensing circuit (the driving electrode Tx and the sensing electrode Rx) for sensing the touch position. In some embodiments, the touch pattern layer T is disposed between the upper polarizer (not shown) and the first substrate 11.

Referring to FIGS. 2A to 2C, the touch display device is a mutual capacitance touch display device for an example. In this case, the touch display device includes the first touch patterns and the second touch patterns. The first touch patterns may be the driving electrodes, and the second touchy patterns may be the sensing electrodes. In another case, the first touch patterns can be the sensing electrodes, and the second touchy patterns can be the driving electrodes. However, according to other embodiments, the touch display device is a self-capacitance touch display device. The touch display device includes the first touch patterns but does not include the second touch patterns. In this case, the first touch patterns are used as the driving electrodes and the sensing electrodes.

As shown in FIGS. 2A and 2B, at least one of the first touch patterns 12 of the touch substrate 2 includes a plurality of bridging portions 121 and a plurality of first electrode portions 122. The first electrode portions 122 are separately disposed, and each bridging portion 121 connects adjacent two of the first electrode portions 122. In this embodiment, the first electrode portions 122 are separately disposed along the first direction D1, and two adjacent first electrode portions 122 are electrically connected by one bridging portion 121. Accordingly, a plurality of first electrode portions 122 and a plurality of bridging portions 121 are connected to form one first touch pattern 12. As shown in FIG. 2A, the first touch patterns 12 are separately disposed along the second direction D2 and are disposed on the first substrate 11. In addition, the bridging portions 121 may include a transparent conductive oxide layer (e.g., ITO or IZO), or a metal layer. The bridging portions 121 may be a single layer structure or a multilayer structure, and this disclosure is not limited thereto.

The first touch patterns 12 and the second touch patterns 13 are intersected and are electrically insulated from each other. At least one of the second touch patterns 13 includes a plurality of connecting portion 131 and a plurality of second electrode portions 132. The second electrode portions 132 are separately disposed, and the first electrode portions 122 and the second electrode portion 132 are separately disposed and intersected. As shown in FIG. 2A, the second touch patterns 13 are separately disposed along the first direction D1 and disposed on the first substrate 11. The second touch patterns 13 are intersected with the first touch patterns 12. In addition, each connecting portion 131 connects two adjacent second electrode portions 132, and the second electrode portions 132 are separately disposed along the second direction D2.

As shown in FIG. 2A, the extending direction of the first touch patterns 12 may be substantially perpendicular to the extending direction of the second touch patterns 13. However, the extending directions of the first touch patterns 12 and the second touch patterns 13 may not be perpendicular to each other and may be adjusted based on the design or the application. For example, the included angle between the extending directions of the first touch patterns 12 and the second touch patterns 13 may be a sharp angle. In addition, although the first electrode portions 122 and the second electrode portions 132 of this embodiment mostly have a polygonal shape, they may be any other shape such as a circle, an ellipse, or other shapes. This disclosure is not limited thereto.

As shown in FIG. 2B, the first touch pattern 12 and the insulation layer 14 are at least partially in direct contact with and overlapped with each other (the insulation layer 14 is not shown in FIG. 2A). In the area without the bridging portion 121, the insulation layer 14 is disposed between the first substrate 11 and the first electrode portion 122, and the insulation layer 14 is in direct contact with the first substrate 11 and overlapped with the first electrode 122 of the first touch pattern 12. In the area disposed with the bridging portion 121, the insulation layer 14 is disposed between the bridging portion 122 of the first touch pattern 12 and the connecting portion 131 of the second touch pattern 13.

The insulation layer 14 includes a protection layer 141 and a dielectric layer 142. The material of the protection layer 141 may include an oxide, such as silicon oxide (SiOₓ), silicon oxynitride (SiOₓN_{y}), or a combination thereof. In addition, the material of the protection layer 141 may include any other organic or inorganic insulation material. The dielectric layer 142 is disposed between the protection layer 141 and the first substrate 11, and the material of the dielectric layer 142 may include silicon nitride (SiNₓ) or silicon oxynitride (SiOₓN_{y}).

In some embodiments, the insulation layer can be overlapped with at least a part of the touch patterns. For example, the insulation layer 14 may be at least partially overlapped with the bridging portions 121 of the first touch pattern 12. In another example, the insulation layer 14 may be at least partially overlapped with the connecting portions 131 of the second touch pattern 13. This disclosure is not limited thereto.

The thickness d3 of the protection layer 141 may be less than the thickness d4 of the dielectric layer 142. The ratio of the thickness d4 of the dielectric layer 142 and the thickness d3 of the protection layer 141 may be greater than or equal to 2, and may be less than or equal to 1000, such as 100 or 500. For example, the ratio of the thickness d4 of the dielectric layer 142 and the thickness d3 of the protection layer 141 may be greater than or equal to 20, and may be less than or equal to 800. In some embodiments, the thickness d3 of the protection layer 141 may be greater than or equal to 5 Å, and may be less than or equal to 200 Å (5 Å≤d3≤200 Å), such as 10 Å, 20 Å, 50 Å, or 150 Å, and the thickness d4 of the dielectric layer 142 may be greater than or equal to 400 Å, and may be less than or equal to 5000 Å (400 Å≤d3≤5000 Å), such as 1000 Å or 2000 Å. For example, the thickness d3 of the protection layer 141 may be 100 Å, and the thickness d4 of the dielectric layer 142 may be 3400 Å.

In practice, after forming the bridging portions 121 on the first substrate 11, the insulation layer 14 may be formed by the chemical vapor deposition (CVD) or physical vapor deposition (PVD) process to cover the bridging portions 121 and the first substrate 11. To be more detailed, the dielectric layer 142 is formed first, and the protection layer 141 is formed on the dielectric layer 141 later. Next, a plurality of through holes O are formed on the insulation layer 14. Then, a transparent conductive layer is formed on the insulation layer 14, and the transparent conductive layer may be filled in the through holes O and be in contact with the bridging portions 121. Afterwards, the profiles of the first electrode portions 122, the second electrode portions 132 and the connecting portions 131 are defined by, for example, the etching process. The first electrode portions 122, the second electrode portions 132 and the connecting portions 131 may be configured in one layer and formed by the same process.

In this embodiment, the first touch patterns 12 and the second touch patterns 13 of the touch display device 1 are disposed at the same side of the first substrate 11 (e.g., a single-sided ITO (SITO) substrate). However, the design of this disclosure may also be applied to other configurations. For example, the first touch patterns 12 and the second touch patterns 13 of the touch display device 1 may be disposed at the opposite sides of the first substrate 11 (e.g., a Double-sided ITO (DITO) substrate). This disclosure is not limited thereto.

In the touch display device 1 of this disclosure, the protection layer 141 including silicon oxynitride is disposed on the dielectric layer 142 for protecting the dielectric layer 142, which includes silicon nitride or silicon oxynitride. This configuration can maintain the insulation property of the dielectric layer 142. Based on the structural design of this disclosure, the insulation property of the dielectric layer of the touch pattern can be remained stable, thereby improving the insulation protection ability and product reliability of the touch display device 1.

In some embodiments, as shown in FIG. 2C, a cover layer 17 may be further provided to cover the first touch pattern 12, the second touch pattern 13, the insulation layer 14 and the first substrate 11. The material of the cover layer 17 may include an organic photoresist, an inorganic material (e.g., SiO₂, SiNₓ, SiOₓN_{y}, or a combination thereof), or an organic photoresist doped with inorganic material. This disclosure is not limited thereto. In the aspect illustrated in FIG. 2C, besides the protection layer 141, the cover layer 17 may be also disposed to maintain the insulation property of insulation layer 14, the first touch pattern 12 and the second touch pattern. Moreover, the configuration of the cover layer 17 can further reduce the probability of the acid corrosion of the touch pattern or the insulation layer 14. In addition, the cover layer 17 may be a hard coating to endure the scratches by external hard objects, thereby further improving the protection ability and product reliability of the touch display device.

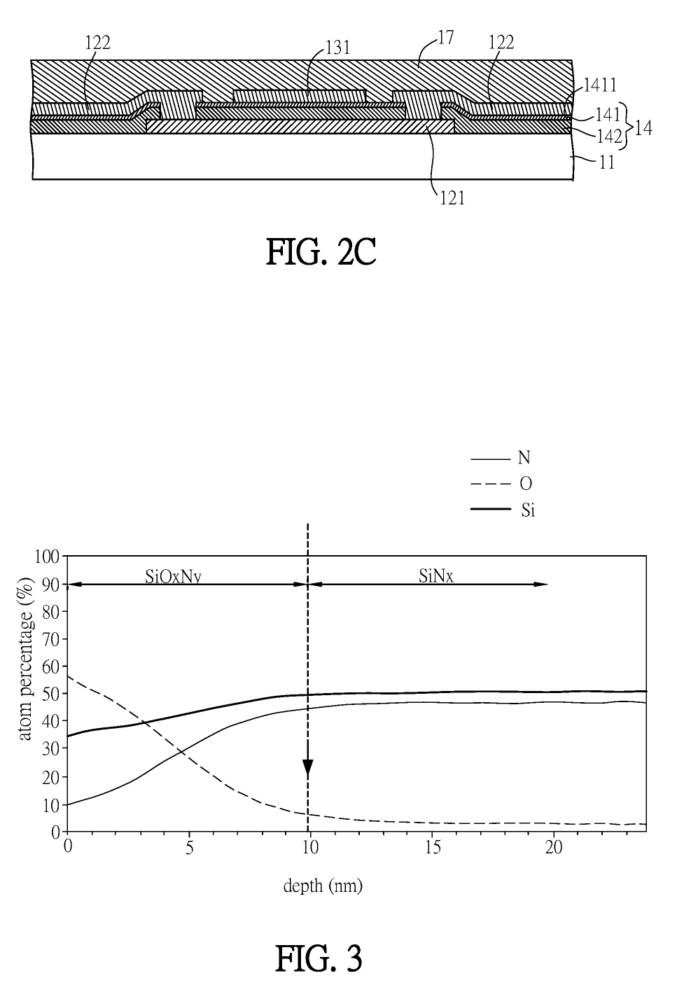

FIG. 3 is a schematic graph showing the atom percentage of the X-ray photoelectron spectrum (XPS) according to an embodiment. This atom percentage curves are obtained by applying XPS toward the top surface 1411 of the protection layer 141 (the direction towards the dielectric layer 142) as shown in FIG. 2B or 2C. The Y axis represents the atom percentage (%), and the X axis represents the depth (mm). The depth starts from the top surface 1411, and the depth of the top surface 1411 is defined as 0 mm. In addition, the material of the protection layer 141 includes, for example, silicon oxynitride (SiOₓN_{y}), and the thickness of the protection layer 141 may be, for example, 10 nm (100 Å). Besides, the material of the dielectric layer 142 includes, for example, silicon nitride (SiNₓ), and the thickness of the dielectric layer 142 may be, for example, 3400 Å.

As shown in FIG. 3, the material of the protection layer 141 is silicon oxynitride (SiOₓN_{y}), so the sum of the percentages of atoms N, O and Si is equal to 100%. According to the three curves of the atoms N, O and Si as shown in FIG. 3, in the depth around 10 nm, atoms N and Si are dominant, and the percentage of the atom O is sharply reduced at the depth approaching 10 nm. When the depth is over 10 nm, the percentage of the atom O in the dielectric layer 142 (SiNₓ) is less than 10% and the percentages of the atoms N and Si are more than 40%. In FIG. 2B or FIG. 2C the insulation layer 14 includes the dielectric layer 142 (SiNₓ) and the protection layer 141 (SiOₓN_{y}) formed on the dielectric layer 142 (SiNₓ) for protecting the dielectric layer 142 according to some embodiments of the disclosure.

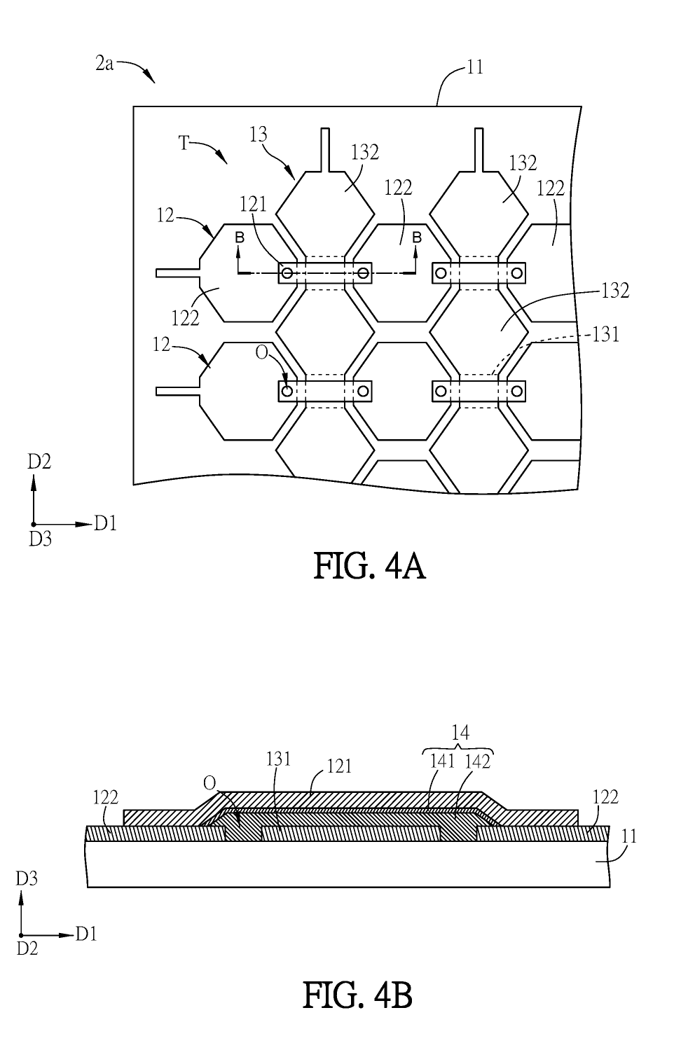

Referring to FIGS. 4A and 4B. FIG. 4A is a top view of a touch substrate 2a of a touch display device of another aspect of the disclosure, and FIG. 4B is a cross-sectional view of the touch substrate 2a of FIG. 4A along the line B-B. Similarly, in the touch substrate 2a, the protection layer 141 including oxide is formed on the dielectric layer 142 including SiNₓ or SiOₓN_{y} for protecting the dielectric layer 142.

In the touch substrate 2 of FIGS. 2A and 2B, the bridging portion 121 of the first touch pattern 12 is disposed between the first substrate 11 and the connecting portion 131 of the second touch pattern 13. Different from the touch substrate 2 of the touch display device 1, in the touch substrate 2a of FIGS. 4A and 4B, the connecting portion 131 of the second touch pattern 13 is disposed between the first substrate 11 than the bridging portion 121 of the first touch pattern 12. To be more detailed, the connecting portion 131 of the second touch pattern 13 of the touch substrate 2a is disposed on the first substrate 11 and in direct contact with the first substrate 11, and the insulation layer 14 is disposed between the connecting portion 131 and the bridging portion 121. In this embodiment, the bridging portion 121 is disposed on a surface of the insulation layer 14 away from the first substrate 11.

Other technical features of the touch substrate 2a may be referred to the same components of the touch substrate 2, so the detailed description thereof will be omitted hereinafter.

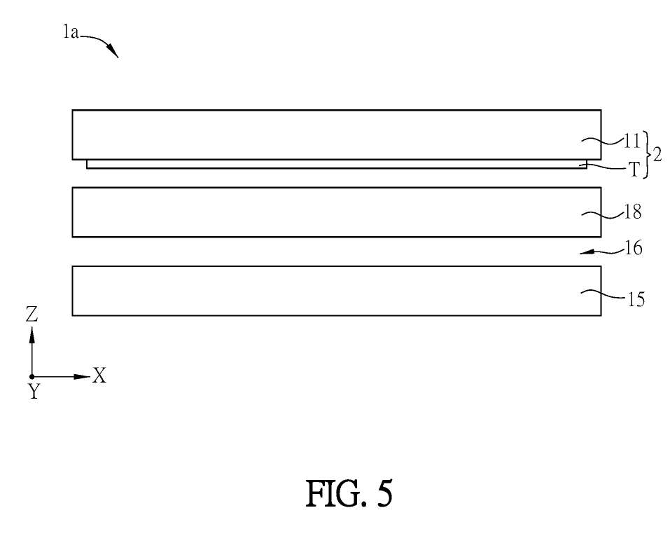

FIG. 5 is a side view of a touch display device la according to another embodiment of the disclosure.

Different from the touch display device 1, the touch display device la of this embodiment further includes a third substrate 18 disposed between the first substrate 11 (or the touch substrate 2 or 2a) and the second substrate 15, and the display medium 16 is disposed between the second substrate 15 and the third substrate 18. In addition, the touch pattern layer T is disposed at one side of the first substrate 11 facing the third substrate 18. In this embodiment, the touch display device 1a is an out-cell touch display device. The first substrate 11 may be, for example, a glass substrate serving as a cover glass, and the touch pattern layer T may be directly formed on the surface of the first substrate 11 facing the third substrate 18. However, in other aspects, another cover substrate may be disposed on the first substrate 11, and this disclosure is not limited thereto. In addition, the third substrate 18 may be, for example, a color filter substrate including a color filter array, and the second substrate 15 may be, for example, a TFT substrate including a TFT array. Thus, the third substrate 18, the display medium 16 and the second substrate 15 may form a liquid crystal display panel.

Other technical features of the touch display device la can be referred to the same components of the touch display device 1, so the detailed description thereof will be omitted hereinafter.

In the above aspects, one insulation layer including a pair of a protection layer and a dielectric layer is provided. In other embodiments, the touch display device may be configured with a plurality of insulation layers. For example, the touch display device may include two or more insulation layers, and at least one of the insulation layers includes the above-mentioned protection layer and dielectric layer. This disclosure is not limited thereto.

The conventional touch pattern layer of the touch display device is usually a transparent conductive layer, which is made of ITO, IZO, AZO, CTO, SnO₂, or ZnO. In most cases, the transparent conductive layer may be made of ITO. Although the transparent conductive layer may be made of ITO, it still has some variations in refractive index, absorption coefficient, and thickness, which will cause the variation in transmittance and reflectivity. For example, the refractive indexes of the amorphous ITO (a-ITO) and the crystal ITO (c-ITO) are different, which will result in different reflective color cast. In addition, different thicknesses of the film can cause different interferences, which may change the color of the film and further cause the color deviation of the dark state of the touch display device.

In order to solve the above problem, the disclosure may adjust the refractive index of the dielectric layer by the CVD or PVD process and the related parameters (e.g., gas ratio, power, etc.). In addition, in some examples, the first touch pattern and the insulation layer may be at least partially overlapped, so that the insulation layer may be served as an index matching film (IMF) of the first touch pattern. Similarly, the second touch pattern and the insulation layer may be at least partially overlapped, so that the insulation layer may be served as an index matching film (IMF) of the second touch pattern. The first touch pattern may be a transparent conductive layer such as an a-ITO layer or a crystal ITO (c-ITO) layer. According to some embodiments, the combination of the touch pattern and the insulation layer can achieve a high transmittance and visibility, and can reduce the reflective color deviation of the dark state. In some embodiments, the dielectric layer of this disclosure is made of silicon nitride or silicon oxynitride and is served as an IMF of the touch pattern layer (the transparent conductive layer). This configuration can obtain a good optical expression so as to reduce the reflective color deviation of the dark state of the transparent conductive layer and to keep the high transmittance and good visibility of the touch display device.

This disclosure is designed based on the refractive index and thickness of the dielectric layer (the IMF) and the transparent conductive layer (touch pattern). The optical expression has the following equation of: nd/λ=(n1×d1+n2×d2)/λ, wherein n is an optical equivalent refractive index of the dielectric layer and the transparent conductive layer, d is an optical equivalent thickness of the dielectric layer and the transparent conductive layer, λ is a light wavelength, n1 is the refractive index of the dielectric layer, d1 is the thickness of the dielectric layer, n2 is the refractive index of the transparent conductive layer, and d2 is the thickness of the transparent conductive layer. Since the ratio of the thickness of the protection layer to the thickness of the dielectric layer is close to 0 Å, the thickness of the protection layer may be omitted.

The suitable thicknesses of the transparent conductive layer and the dielectric layer may be obtained from the above optical equation. Therefore, thickness of the transparent conductive layer may be in a range from 200 Å to 750 Å or from 1000 Å to 1600 Å, such as 300 Å, 500 Å, 1200 Å, or 1400 Å, and the thickness of the dielectric layer may be greater than or equal to 400 Å and may be less than or equal to 5000 Å (400 Å≤d1≤5000 Å), such as 1000 Å, 2000 Å, 3000 Å, or 4000 Å. In addition, when the material of the transparent conductive layer includes a-ITO, the refractive index thereof may be greater than or equal to 1.8 and may be less than or equal to 2.2 (2.0±0.2). When the material of the transparent conductive layer includes c-ITO, the refractive index thereof may be greater than or equal to 1.6 and may be less than or equal to 2.0 (1.8±0.2). In addition, when the material of the dielectric layer includes silicon nitride, the refractive index thereof may be greater than or equal to 1.7 and may be less than or equal to 2.0 (1.85±0.15). When the material of the dielectric layer includes silicon oxynitride, the refractive index thereof may be greater than or equal to 1.46 and may be less than or equal to 1.90 (1.68±0.22).

Based on the above data, proper simulations and experiments show that when nd/λ=(0.5a+0.1)±0.1 (a=1, 2, 3, 4, 5, . . . ), the corresponding thicknesses of the dielectric layer and the transparent conductive layer will have a good optical performance. Accordingly, this disclosure can utilize the above-mentioned dielectric layer in cooperation with the transparent conductive layer to effectively reduce the reflective color deviation of the dark state and to keep the high transmittance and good visibility of the touch display device.

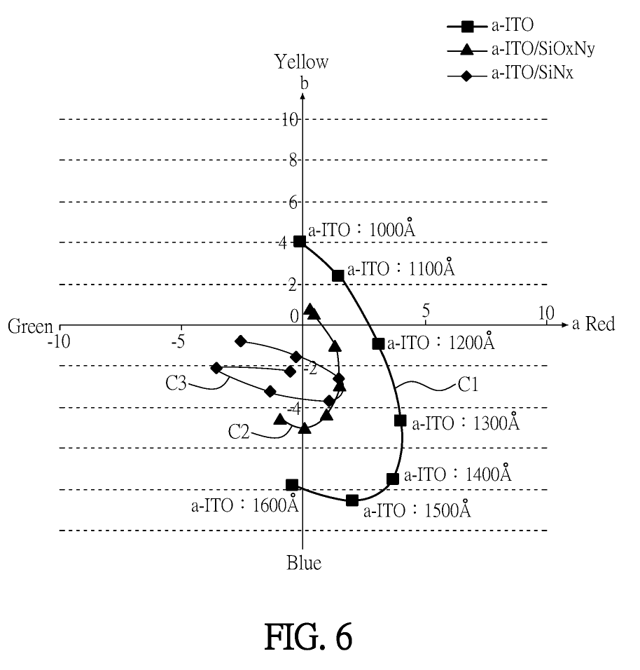

FIG. 6 is a CIE 1976 chromaticity diagram of an embodiment of the disclosure. The curve C1 is the result of the transparent conductive layer (a-ITO) without the dielectric layer of this disclosure. According to the curve C1, the a-ITO layer with different thicknesses may have different color tones. For example, when the thickness of the a-ITO layer is 1400 Å, the a-ITO layer can have a good transmittance, but it will have a color tone bias to reddish blue (purple). If the index matching film (the dielectric layer) of this disclosure is provided to cooperate with the transparent conductive layer, the curve C2 (a-ITO and SiOₓN_{y}) and the curve C3 (a-ITO and SiNₓ) can be obtained. Herein, the cases of the curves C2 and C3 have optimized the thicknesses of the transparent conductive layer and the IMF. The curves C2 and C3 show that the entire optical expressions are close to the center (bias to black). These results proves that the proper designs of the index matching film (the dielectric layer) and the transparent conductive layer can effectively reduce the reflective color tone deviation of the dark state of the touch display device.

As mentioned above, in the touch display device of this disclosure, the material of the protection layer includes an oxide material and the protection layer is disposed on the dielectric layer for protection the dielectric layer, and the material of the dielectric layer includes silicon nitride or silicon oxynitride. This configuration can maintain the insulation property of the dielectric layer. Based on the structural design of this disclosure, the insulation property of the dielectric layer of the touch pattern can be remained stable, thereby improving the insulation protection ability and product reliability of the touch display device. According to some embodiments, the dielectric layer can also be used as an index matching film (IMF) cooperated with the transparent conductive layer (touch pattern) for reducing the color tone deviation of the dark state of the touch display device and keeping the high transmittance and good visibility.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A touch display device, comprising:
a first substrate;
a first touch pattern disposed on the first substrate; and
an insulation layer disposed on the first substrate, wherein the insulation layer and the first touch pattern are overlapped, and the insulation layer comprises:
a protection layer, wherein a material of the protection layer comprises an oxide; and
a dielectric layer disposed between the protection layer and the first substrate, wherein a material of the dielectric layer comprises silicon nitride or silicon oxynitride.

2. The touch display device according to claim 1, further comprising:
a second substrate disposed opposite to the first substrate; and
a display medium layer disposed between the first substrate and the second substrate.

3. The touch display device according to claim 2, wherein the display medium layer comprises a liquid crystal layer, a light-emitting diode layer, or an organic light-emitting diode layer.

4. The touch display device according to claim 1, wherein the touch display device is a mutual capacitance touch display device or a self-capacitance touch display device.

5. The touch display device according to claim 1, further comprising:
a second touch pattern disposed on the first substrate, wherein the first touch pattern and the second touch pattern are intersected.

6. The touch display device according to claim 5, wherein the first touch pattern has a plurality of bridging portions and a plurality of first electrode portions, the second touch pattern has a plurality of connecting portions and a plurality of second electrode portions, one of the bridging portions connects adjacent two of the first electrode portions, one of the connecting portions connects adjacent two of the second electrode portions, and the insulation layer is disposed between the one of the bridging portions and the one of the connecting portions.

7. The touch display device according to claim 6, wherein the first electrode portions are arranged along a first direction.

8. The touch display device according to claim 7, wherein a plurality of the first touch patterns are arranged along a second direction, and the first direction and the second direction has an included angle.

9. The touch device according to claim 5, wherein the first touch pattern, the second touch pattern, and the insulation layer form a touch pattern layer, and the touch pattern layer and the first substrate form a touch substrate.

10. The touch display device according to claim 6, wherein one of the bridging portions is disposed between the first substrate and one of the connecting portions.

11. The touch display device according to claim 6, wherein the one of the connecting portions is disposed between the first substrate and one of the bridging portions.

12. The touch display device according to claim 1, wherein a thickness of the dielectric layer is greater than or equal to 400 Å and less than or equal to 5000 Å.

13. The touch display device according to claim 1, wherein a thickness of the protection layer is greater than or equal to 5 Å and less than or equal to 200 Å.

14. The touch display device according to claim 1, wherein the oxide of the protection layer is silicon oxide, silicon oxynitride, or a combination thereof.

15. The touch display device according to claim 6, wherein the first electrode portions, the second electrode portions and the connecting portions are in a same layer.

16. The touch display device according to claim 1, wherein a thickness of the protection layer is less than a thickness of the dielectric layer.

17. The touch display device according to claim 1, wherein a ratio of a thickness of the dielectric layer and a thickness of the protection layer is greater than or equal to 2, and is less than or equal to 1000.

18. The touch display device according to claim 1, further comprising:
a cover layer disposed on the first touch pattern, the insulation layer and the first substrate, and a material of the cover layer is different from the material of the protection layer.

19. The touch display device according to claim 1, wherein a material of the dielectric layer comprises silicon nitride, and a refractive index of the dielectric layer is greater than or equal to 1.7 and is less than or equal to 2.0.

20. The touch display device according to claim 1, wherein a material of the dielectric layer comprises silicon oxynitride, and a refractive index of the dielectric layer is greater than or equal to 1.46 and is less than or equal to 1.90.
